(19) United States
(12) Patent Application Publication
(10) Pub. No.: US 2007/0019452 A1
(43) Pub. Date: Jan. 25, 2007

(54) Electronic apparatus and sensor network system

(75) Inventors: Norio Ohkubo, Tokyo (JP); Norihiko Moriwaki, Hachioji (JP); Yoshihiro Wakisaka, Kokubunji (JP); Shunzo Yamashita, Musashino (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/356,170

(22) Filed: Feb. 17, 2006

(30) Foreign Application Priority Data
Jul. 11, 2005 (JP) 2005-201434

(51) Int. Cl. H02M 7/00

(52) U.S. Cl. 363/101

(57) ABSTRACT

Provided is a technique of reducing time and labor of replacing and charging the battery. This invention provides an electronic apparatus, which has a name written on a front side thereof, including: a radio communication apparatus; a secondary battery; a solar battery on the front side; and a display unit on a backside thereof, in which the solar battery is installed to be tilted to make a distance between an upper side thereof and the display unit smaller than a distance between a lower side thereof and the display unit.

### CLAIM OF PRIORITY

The present application claims priority from Japanese patent application P2005-201434 filed on Jul. 11, 2005, the content of which is hereby incorporated by reference into this application.

### BACKGROUND OF THE INVENTION

This invention relates to an electronic apparatus for performing radio communication, and more particularly to an electronic apparatus which can be carried by a person.

Developments of a sensor network system constituted of a sensor node and a server have been proceeding in recent years. The sensor node is carried by a person or the like and measures a state or the like (sensor data) of the person. The sensor node then transmits the measured sensor data to the server. The server executes various processes based on the received sensor data.

The conventional sensor node includes a primary or secondary battery as a power source.

However, the primary battery has had a problem in that it must be replaced. The secondary battery has had a problem in that it must be recharged.

A node that solves the problems is disclosed in JP 08-223067 A. The node includes a solar battery and a secondary battery, and the secondary battery is recharged with power generated by the solar battery.

### SUMMARY OF THE INVENTION

In the case of the conventional node, however, the power generated by the solar battery is too weak to supply sufficient power to the secondary battery. Thus, the secondary battery must be externally charged even when the conventional node includes the solar battery.

This invention has been made in view of the foregoing problems, and has an object to provide a node in which there is no need to replace and recharge a battery.

This invention provides an electronic apparatus, which has a name written on a front side thereof, including: a radio communication apparatus; a secondary battery; a solar battery on the front side; and a display unit on a backside thereof, in which the solar battery is installed to be tilted to make a distance between an upper side thereof and the display unit smaller than a distance between a lower side thereof and the display unit.

According to an embodiment of this invention, there is no need to replace and recharge the battery.

### BRIEF DESCRIPTION OF THE DRAWINGS

The present invention can be appreciated by the description which follows in conjunction with the following figures, wherein:

FIG. 1 is a block diagram of a sensor network system according to a first embodiment of this invention;

FIG. 2 is a block diagram of a name tag type node according to the first embodiment of this invention;

FIG. 3A is a front diagram of the name tag type node according to the first embodiment of this invention;

FIG. 3B is a back diagram of the name tag type node according to the first embodiment of this invention;

FIG. 4 is a side diagram of the name tag type node according to the first embodiment of this invention;

FIG. 5 is a side diagram of the name tag type node according to the first embodiment of this invention;

FIG. 6 is an explanatory diagram of the name tag type node according to the first embodiment of this invention;

FIG. 7 is an explanatory diagram of power of the name tag type node according to the first embodiment of this invention;

FIG. 8 is an explanatory diagram of power of the name tag type node according to the first embodiment of this invention;

FIG. 9 is a block diagram of an event action control unit of a server according to the first embodiment of this invention;

FIG. 10 is a diagram showing a composition of an event action table according to the first embodiment of this invention;

FIG. 11 is a sequential diagram of a message transmission/reception process of the sensor network system according to the first embodiment of this invention;

FIG. 12 is a sequential diagram of a message transmission/reception process of the name tag type node according to the first embodiment of this invention;

FIG. 13 is a sequential diagram of a message transmission/reception process to be performed between name tag type nodes according to the first embodiment of this invention;

FIG. 14 is a block diagram of a sensor network system according to a second embodiment of this invention;

FIG. 15 is an explanatory diagram of how the sensor network system of the second embodiment of this invention is installed; and

FIG. 16 is a sequential diagram of a position detection process of the sensor network system according to the second embodiment of this invention.

### DETAILED DESCRIPTION OF THE PREFERRED EMBODIMENTS

The preferred embodiments of this invention will be described with reference to the accompanying drawings.

### First Embodiment

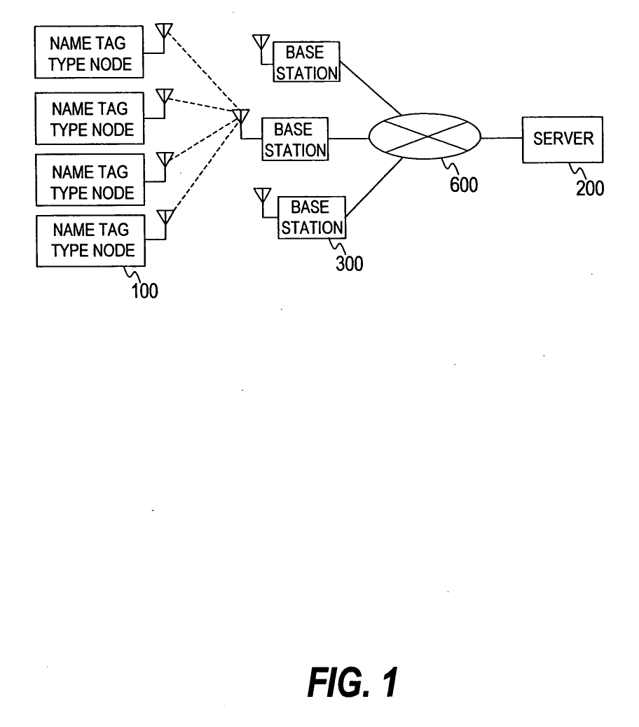

FIG. 1 is a block diagram of a sensor network system according to a first embodiment of this invention.

The sensor network system includes a name tag type node 100, a server 200, a base station 300, and a network 600.

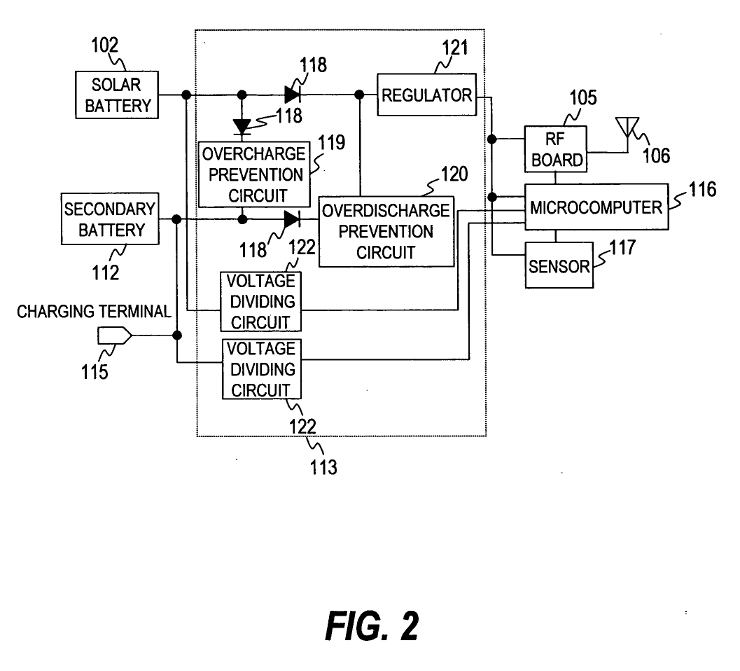

As described below referring to FIGS. 2 to 6, the name tag type node 100 is an electronic apparatus which communicates with the server 200 through the base station 300. The name tag type node 100 functions as a name tag by having a name or the like written on its front side. For example, a person carries the name tag type node 100 by dangling it from a neck, or by attaching it to clothes by a clip or the like. The name tag type node 100 is carried to be used in an exhibition hall, a lecture hall, a company, a hospital, public facilities, or the like.

The network 600 interconnects the server 200 and the base station 300.

The base station 300 communicates with the name tag type node 100 by radio. The base station 300 transfers data received from the name tag type node 100 to the server 200. Similarly, the base station 300 transfers data received from the server 200 to the name tag type node 100.

The name tag type node 100 may include a function of the base station 300. In this case, the name tag type node 100 transfers data received from another name tag type node 100 to the server 200.

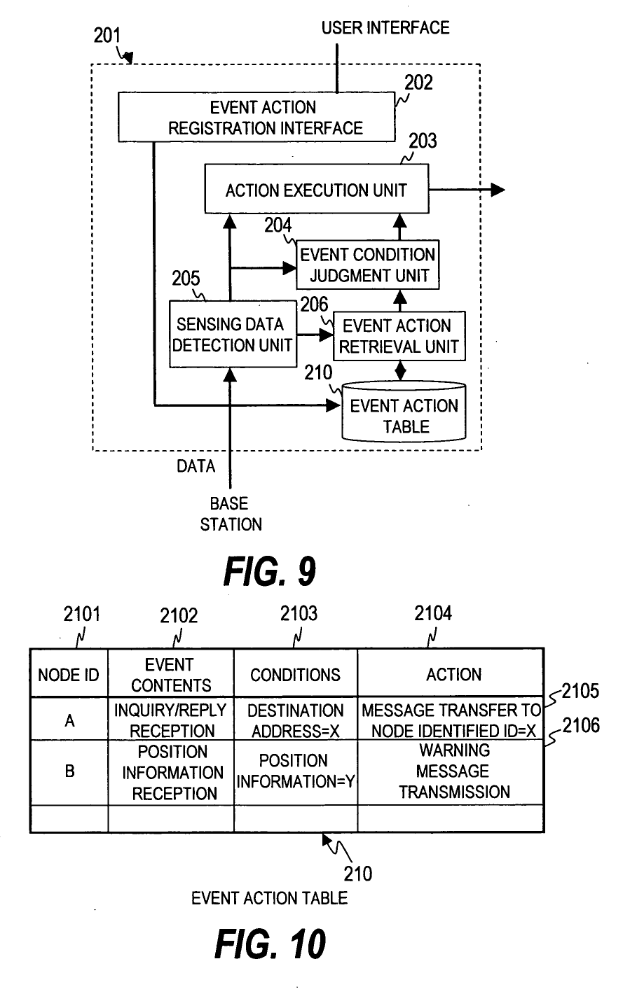

The server 200 is a computer which includes an event action control unit described below with reference to FIG. 9.

FIG. 2 is a block diagram of the name tag type node 100 according to the first embodiment of this invention.

The name tag type node 100 includes a solar battery 102, a secondary battery 112, a charging terminal 115, a power source board 113, an RF board 105, a microcomputer 116, a sensor 117, and an antenna 106.

The solar battery 102 generates power by taking out power from sunlight. It should be noted that the name tag type node 100 may include, in place of the solar battery 102, a generator for generating power by using another method.

The secondary battery 112 supplies power to the name tag type node 100. The secondary battery 112 has ratings in current and voltage for charging. Also, the secondary battery 112 has ratings in current and voltage for discharging. For example, the secondary battery 112 is a lithium-ion battery. The lithium-ion battery is best suited to the secondary battery 112, because it has a large capacity per unit volume, and is not affected by a memory effect during charging.

The charging terminal 115 charges the secondary battery 112 when it is connected to an external power source.

The power source board 113 includes a diode 118, an overcharge prevention circuit 119, an overdischarge prevention circuit 120, a regulator 121, and a voltage dividing circuit 122.

The diode 118 is a semiconductor which supplies a current only in one direction.

The overcharge prevention circuit 119 prevents overcharge of the secondary battery 112. The overdischarge prevention circuit 120 prevents overdischarge of the secondary battery 112.

The regulator 121 makes constant a voltage supplied to the RF board 105, the microcomputer 116, and the sensor 117.

The voltage dividing circuit 122 sets a voltage of the solar battery 102 and a voltage of the secondary battery 112 to a constant ratio. Specifically, the voltage dividing circuit 122 sets the voltage of the solar battery 102 or the voltage of the secondary battery 112 to a voltage that can be measured by the microcomputer 116.

The RF board 105 has a circuit for radio communication mounted thereon. The RF board 105 communicates with the base station 300 through the antenna 106 by radio.

The microcomputer 116 controls the entire name tag type node 100. For example, the microcomputer 116 measures the voltage of the secondary battery 112. Then, it estimates a charging period of the secondary battery based on the measured voltage of the secondary battery 112.

The microcomputer 116 measures the voltage of the solar battery 102. Then, it obtains illuminance around the name tag type node 100 based on the measured voltage of the solar battery 102. When the obtained illuminance is low, the microcomputer 116 may control the name tag type node 100 to reduce power consumption.

The microcomputer 116 may be started at a predetermined cycle and set in a sleep state in other cases to thereby reduce power consumption of the microcomputer 116.

The sensor 117 obtains various pieces of information on a temperature, humidity, and acceleration.

Next, a power flow of the name tag type node 100 will be described.

Power generated by the solar battery 102 flows through the diode 118 and the overcharge prevention circuit 119 to charge the secondary battery 112.

The power charged to the secondary battery 112 flows through the diode 118, the overdischarge prevention circuit 120, and the regulator 121 to be supplied to the RF board 105, the microcomputer 116, and the sensor 117.

The voltage of the solar battery 102 may be set higher than that of the secondary battery 112 to thereby permit the solar battery 102 to directly supply the power to the RF board 105, the microcomputer 116, and the sensor 117.

In other words, the solar battery 102 provided to the name tag type node 100 of this embodiment eliminates the need to replace and recharge the battery. This is particularly effective for the sensor network system which includes many name tag type nodes 100.

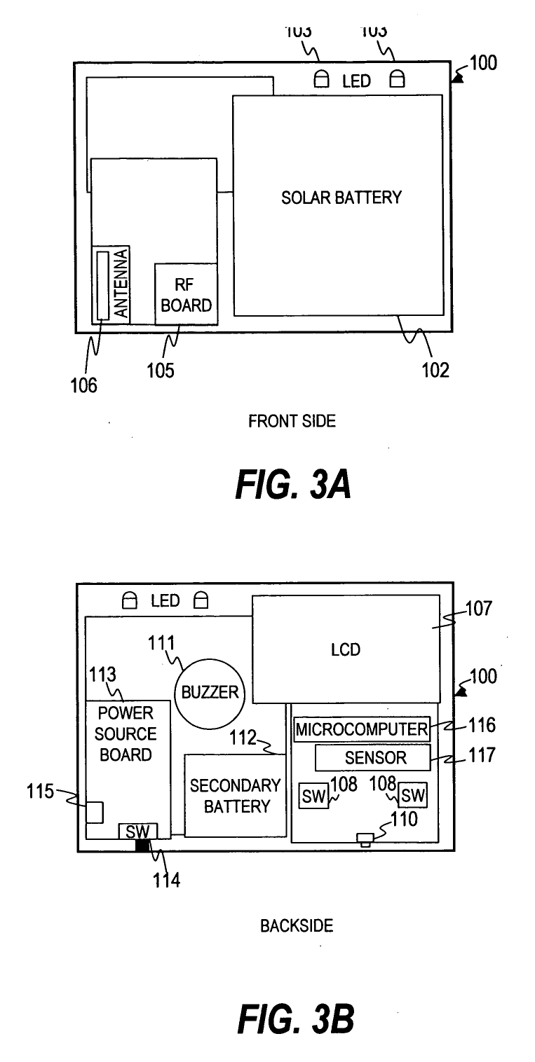

FIG. 3A is a front diagram of the name tag type node 100 according to the first embodiment of this invention.

The solar battery 102, the LED 103, the RF board 105, and the antenna 106 are installed on a front side of the name tag type node 100.

The LED 103 emits a light when predetermined conditions are satisfied. For example, the LED 103 emits a light when the name tag type node 100 receives information from the server 200 to thereby notify the reception of the information to the user.

The solar battery 102, the LED 103, the antenna 106, and the name tag type node 100 shown in the block diagram of FIG. 2 have been described, and thus description thereof will be omitted.

The antenna 106 is installed in a position far from the solar battery 102 and the LCD 107. Especially, the antenna 106 is disposed not to overlap the solar battery 102 or the LCD 107 when viewed from the front. This is because the solar battery 102 and the LCD 107 obstruct communication performed through the antenna 106.

FIG. 3B is a back diagram of the name tag type node 100 according to the first embodiment of this invention.

The LCD 107, an operation switch 108, a reset switch 110, a buzzer 111, a secondary battery 112, the power source board 113, a power supply switch 114, the charging terminal 115, the microcomputer 116, and the sensor 117 are installed in a backside of the name tag type node 100.

The LCD 107 is a liquid crystal display for displaying various pieces of information. The name tag type node 100 may include another type of display in place of the LCD 107.

The operation switch 108 is operated by the user. The user operates the operation switch 108 to input various pieces of information to the name tag type node 100. The user operates the operation switch 108 to select displaying or nondisplaying of the LCD 107. Thus, it is possible to reduce power consumption of the LCD 107.

The reset switch 110 resets the name tag type node 100 when it is operated by the user.

The buzzer 111 emits a sound when predetermined conditions are satisfied. For example, the buzzer 111 emits a sound when the name tag type node 100 receives information from the server 200. Accordingly, the buzzer 111 can notify the reception of the information to the user.

The power supply switch 114 switches between power ON and OFF of the name tag type node 100.

The secondary battery 112, the power source board 113, the charging terminal 115, the microcomputer 116, and the sensor 117 shown in the bock diagram of FIG. 2 of the name tag type node 100 have been described, and thus description thereof will be omitted.

The name tag type node 100 can have the solar battery 102 of a large area on its front side by including the LCD 107, the operation switch 108, and the like on its backside. Hence, it is possible to increase a power generation amount of the solar battery 102.

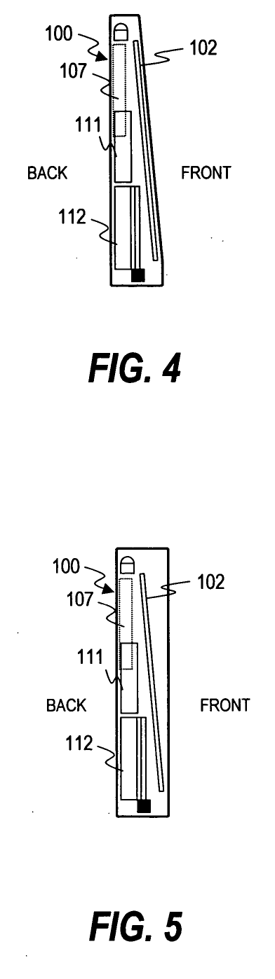

FIG. 4 is a side diagram of the name tag type node 100 according to the first embodiment of this invention.

The solar battery 102 is installed to be tilted upward. Specifically, the solar battery 102 is disposed to be tilted such that a distance between its upper side and the LCD 107 is made smaller than that between its lower side and the LCD 107. Accordingly, the solar battery 102 can obtain light more efficiently to generate large power. For example, a solar battery 102 installed to be tilted by an angle of 5° with respect to the LCD 107 can generate power larger by 30 to 40% than that of a solar battery installed in parallel with the LCD 107.

The name tag type node 100 is made thinner at its upper portion than at its bottom portion. Accordingly, the name tag type node 100 does not bring any discomfort to the user even when the name tag type node 100 includes the solar battery tilted upward.

The secondary battery 112 is installed lower than a center of the name tag type node 100 or the solar battery 102. The upper portion of the name tag type node 100 can be made thinner by including the thick secondary battery 112 in its lower portion.

The name tag type node 100 may take a form shown in FIG. 5.

FIG. 5 is a side diagram of the name tag type node 100 according to the first embodiment of this invention.

Different from the name tag type node 100 of FIG. 4, the name tag type node 100 of this explanatory diagram has uniform thickness. Other components are similar to those of the name tag type node of FIG. 4, and thus description thereof will be omitted.

In other words, irrespective of the thickness of the name tag type node 100, the solar battery 102 can generate large power by being installed to be tilted upward.

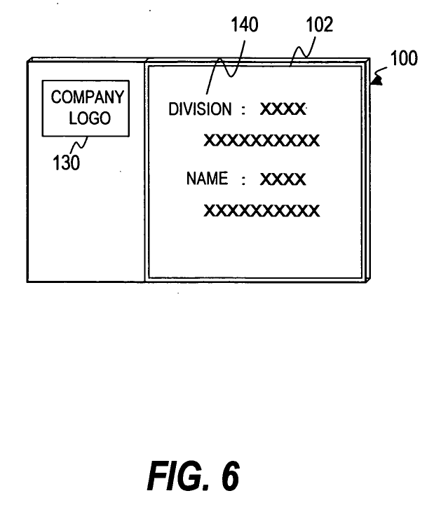

FIG. 6 is an explanatory diagram of the name tag type node 100 according to the first embodiment of this invention.

A transparent film 140 is installed at the front of the solar battery 102. Information containing a division to which a user belongs, a user name, and the like is written on the transparent film 140. Thus, the name tag type node 100 functions as a name tag. The name tag type node 100 can include a solar battery 102 of a large area by having the transparent film 140, on which the information is written, placed at the front of the solar battery 102.

A front portion other than a portion corresponding to the solar battery 102 does not need to be transparent. For example, a company logo 130 or the like is written on the front portion other than the portion corresponding to the solar battery 102.

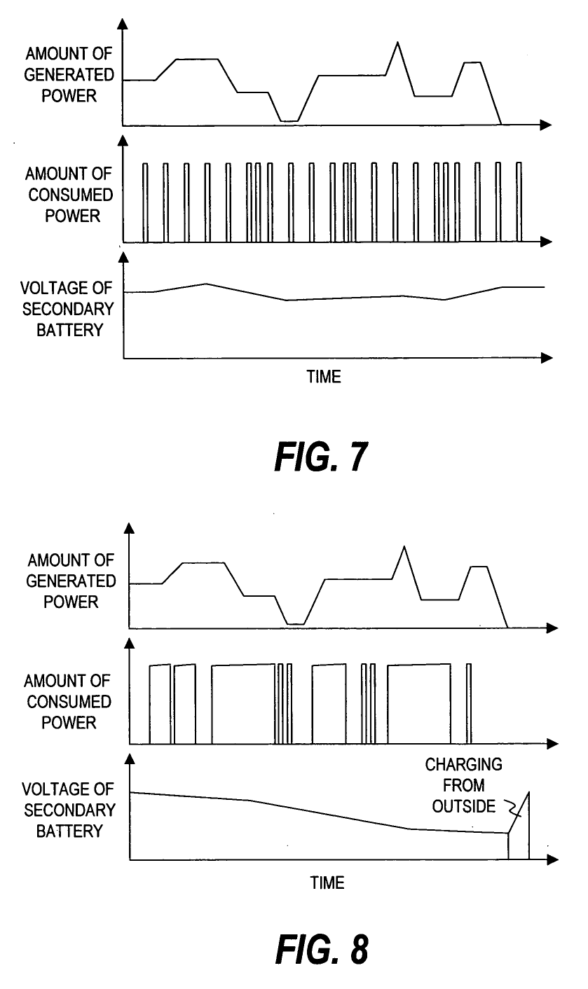

FIG. 7 is an explanatory diagram of power of the name tag type node 100 according to the first embodiment of this invention.

This explanatory diagram shows a case where a power generation amount of the solar battery 102 exceeds a power consumption amount of the name tag type node 100.

The explanatory diagram includes a graph regarding a power generation amount of the solar battery 102, a power consumption amount of the name tag type node 100, and a voltage of the secondary battery 112. An abscissa of each of these graphs indicates time.

As shown in the explanatory diagram, the power generation amount of the solar battery 102 greatly changes depending on time. On the other hand, the name tag type node 100 operates at a predetermined interval to consume power at a predetermined interval.

As shown in the explanatory diagram, the power generation amount of the solar battery 102 exceeds the power consumption amount of the name tag type node 100. Thus, a voltage of the secondary battery 112 is substantially maintained constant. In this case, the name tag type node 100 does not need any charging from outside.

FIG. 8 is an explanatory diagram of power of the name tag type node 100 according to the first embodiment of this invention.

This explanatory diagram shows a case where a power generation amount of the solar battery 102 is smaller than a power consumption amount of the name tag type node 100.

The explanatory diagram includes a graph regarding a power generation amount of the solar battery 102, a power consumption amount of the name tag type node 100, and a voltage of the secondary battery 112. An abscissa of each of these graphs indicates time.

As shown in the explanatory diagram, the power generation amount of the solar battery 102 is smaller than the power consumption amount of the name tag type node 100. Thus, a voltage of the secondary battery 112 gradually decreases. In this case, the name tag type node 100 needs to be externally charged.

FIG. 9 is a block diagram of an event action control unit 201 of the server 200 according to the first embodiment of this invention.

The event action control unit 201 includes an event action registration interface 202, an action execution unit 203, an event condition judgment unit 204, a sensing data detection unit 205, an event action retrieval section 206, and an event action table 210.

First, the event action table 210 will be described.

FIG. 10 is a diagram showing a composition of the event action table 210 according to the first embodiment of this invention.

The event action table 210 contains a node ID 2101, event contents 2102, a condition 2103, and an action 2104.

The node ID 2101 is a unique identifier of the name tag type node 100.

The event contents 2102 and the condition 2103 are requirements for generating an event of a corresponding record.

The event contents 2102 are types of sensor data received by the event action control unit 201. For example, inquiry/reply reception (for a record 2105), position information reception (for a record 2106), or the like is stored in the event contents 2102.

The condition 2103 is for relating sensor data received by the event action control unit 201 to a corresponding record. Destination address information of the sensor data (for the record 2105), position information of the name tag type node 100 which has transmitted the sensor data (for the record 2106), or the like is stored in the conditions 2103. Other conditions such as measuring time of the sensor data and a changing amount of the sensor data may be stored as the condition 2103.

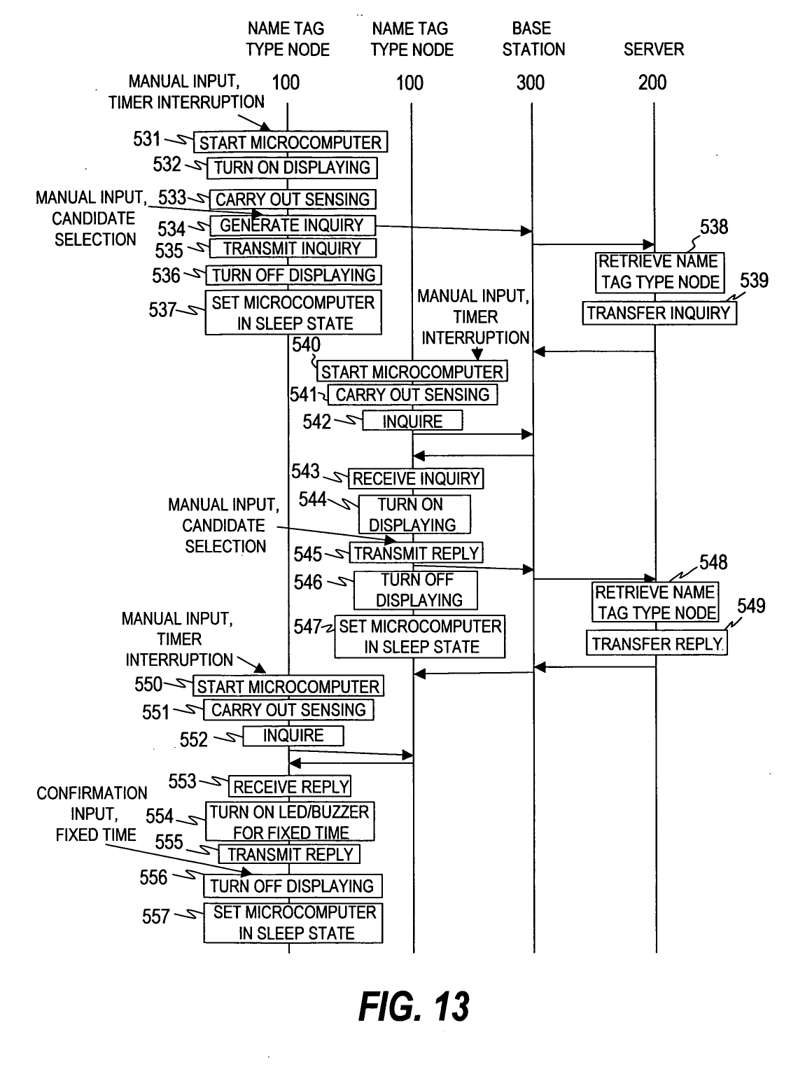

The action 2104 indicates processing contents at an occurrence of an event. For example, the action 2104 may be message transfer processing (for the record 2105), or warning message transmission processing (for the record 2106). The message transfer processing shown in FIG. 13 will be described below. Other processing contents may be stored as the action 2104.

Now, referring back to FIG. 9, description will be made.

When updating contents of the event action table 210, a management user inputs an event updating request through the user interface. It should be noted that the event updating request is for registering, changing, or deleting records in the event action table 210.

The input event updating request is sent though the user interface to the event action registration interface 202. The event action registration interface 202 updates the event action table 210 based on the received event updating request.

The sensing data detection unit 205 receives information (sensor data) obtained by the name tag type node 100 from the base station 300, and sends the information to the event action retrieval unit 206.

The event action retrieval unit 206 determines a name tag type node 100 which has transmitted the sensor data. Next, the event action retrieval unit 206 judges whether a record having a node ID 2101 that corresponds to an identifier of the determined name tag type node 100 exists in the event action table 210. Accordingly, judgment is made as to whether an event regarding the name tag type node 100 exists in the event action table 210. If the event exists in the event action table 210, the received sensor data is sent to the event condition judgment unit 204.

The event condition judgment unit 204 judges whether the received sensor data satisfies the event contents 2102 and the conditions 2103 in the event action table 210 or not. If the event contents 2102 and the conditions 2103 are satisfied, an action 2104 is extracted from a record which satisfies these conditions. Then, the extracted action 2104 is notified to the action execution unit 203.

The action execution unit 203 executes the notified action 2104.

As described above, the event action control unit 201 executes processing corresponding to the received sensor data. The event action control unit 201 executes various processing operations, whereby diverse ubiquitous applications can be realized.

Next, description will be made of a process when the name tag type node 100 is used as a communication tool.

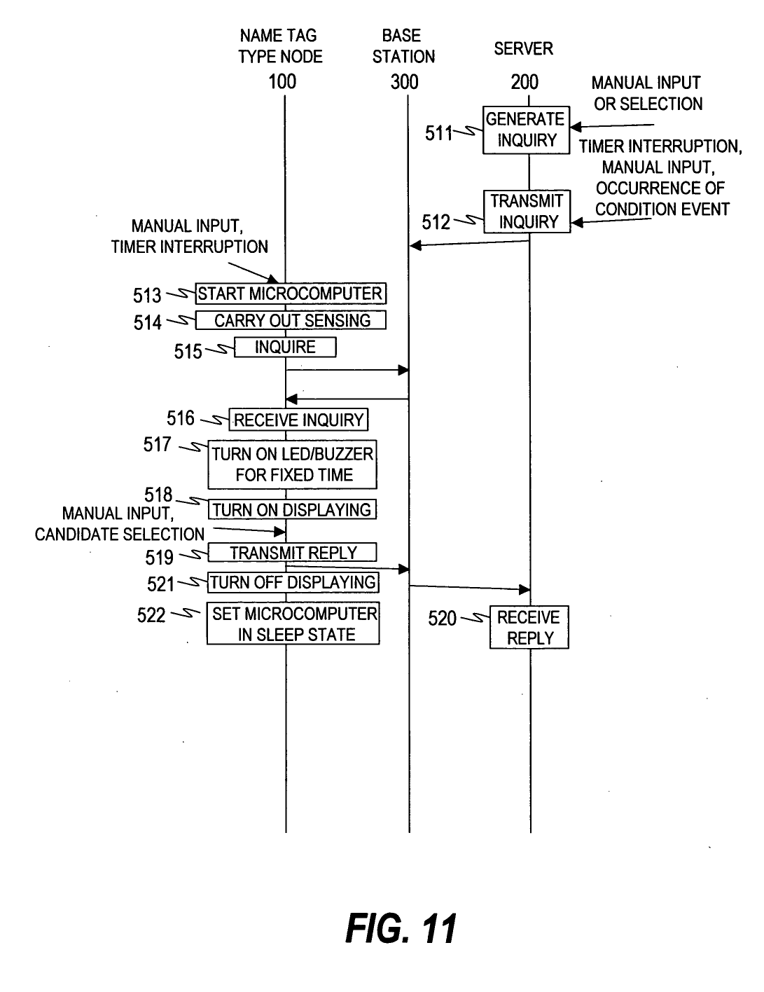

FIG. 11 is a sequential diagram of a message transmission/reception process of the sensor network system according to the first embodiment of this invention.

The management user inputs a message for the user of the name tag type node 100 to the server 200. The management user may also select a message to be transmitted to the name tag type node 100 from among the messages preregistered in the server 200. In this case, the message is an inquiry message to the user of the name tag type node 100.

The server 200 generates an inquiry message based on information input from the management user (511). At this time, the server 200 includes a node ID of a name tag type node 100 to which the massage is to be transmitted in the inquiry message to designate a destination address of the inquiry message.

Next, the server 200 transmits the generated inquiry message to the base station 300 at predetermined timing (512). The predetermined timing includes a time point when a transmission request is received from the user, when fixed time expires, or when a condition event occurs.

Then, the base station 300 receives the inquiry message from the server 200. The base station 300 holds the received inquiry message.

On the other hand, the name tag type node 100 starts the microcomputer 116 at a predetermined cycle (513). It should be noted that the name tag type node 100 also starts the microcomputer 116 when information is input from the user.

Next, the name tag type node 100 obtains (senses) various pieces of information by using the sensor 117 (514).

Subsequently, the name tag type node 100 makes an inquiry by radio to the base station 300 about whether the base station 300 holds the message addressed to the name tag type node 100 (515).

Upon reception of the inquiry from the name tag type node 100, the base station 300 judges whether it holds a message addressed to the name tag type node 100 or not.

If it is judged that the message addressed to the name tag type node 100 is not held, the base station 300 informs the name tag type node 100 to that effect.

On the other hand, if it is judged that the message addressed to the name tag type node 100 is held, the base station 300 transmits the message to the name tag type node 100.

Then, the name tag type node 100 receives the inquiry message from the base station 300 (516).

Upon reception of the inquiry message, the name tag type node 100 lights the LED 103 for a fixed time, and sounds the buzzer 111 for a fixed time simultaneously (517). Accordingly, the name tag type node 100 notifies the reception of the message to the user.

Next, the name tag type node 100 displays the received inquiry message on the LCD 107.

The user inputs a reply for the displayed inquiry message to the name tag type node 100. The user may also select a reply message to be returned to the server 200 from among the reply messages preregistered in the name tag type node 100.

The name tag type node 100 generates a reply message based on the information input from the user. Then, the generated reply message is transmitted to the base station 300 (519).

Next, the name tag type node 100 turns OFF the displaying on the LCD 107 (521). The name tag type node 100 sets the microcomputer 116 in a sleep state (522).

Meanwhile, the base station 300 receives the reply message from the name tag type node 100, and transfers the received reply message to the server 200.

The server 200 receives the reply message from the base station 300 (520).

As described above, the server 200 receives the reply message to the inquiry message from the name tag type node 100.

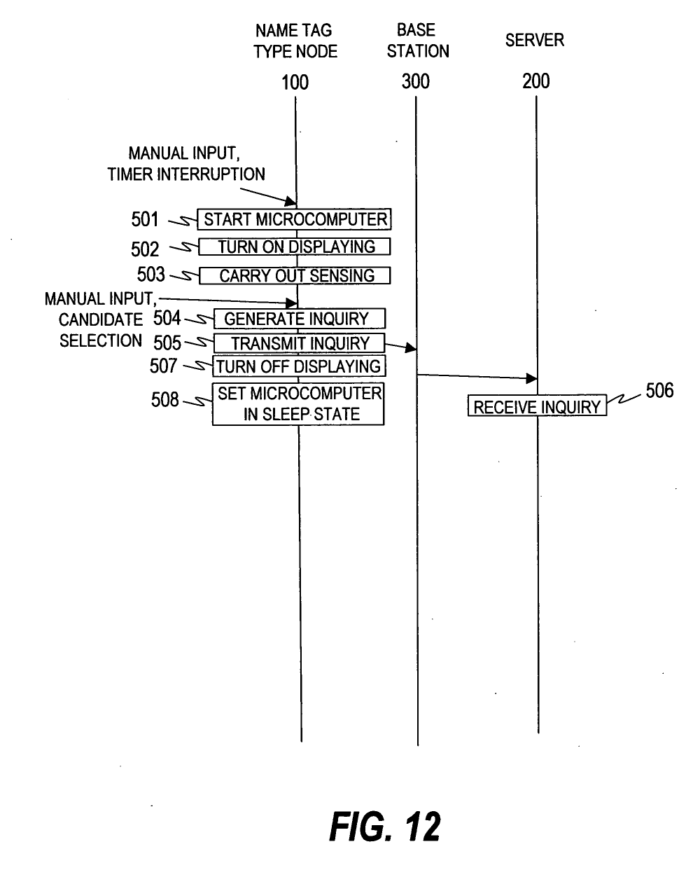

FIG. 12 is a sequential diagram of a message transmission process of the name tag type node 100 according to the first embodiment of this invention.

The name tag type node 100 starts the microcomputer 116 at a predetermined cycle (501). It should be noted that the name tag type node 100 also starts the microcomputer 116 when information is input from the user.

Next, the name tag type node 100 turns ON displaying on the LCD 107 (502). The name tag type node 100 obtains (senses) various pieces of information by using the sensor 117 (503).

The user inputs a message for the management user to the name tag type node 100. In this case, the user inputs an inquiry to the management user. The user may also select an inquiry message to be transmitted to the server 200 from among the inquiry messages preregistered in the name tag type node 100.

The name tag type node 100 generates an inquiry message based on the information input from the user (504). Then, the name tag type node 100 transmits the generated inquiry message to the base station 300 (505).

Next, the name tag type node 100 turns OFF the displaying on the LCD 107 (507).

The name tag type node 100 sets the microcomputer 116 in a sleep state (508).

Meanwhile, the base station 300 receives the inquiry message from the name tag type node 100, and transfers the received inquiry message to the server 200.

The server 200 receives the inquiry message from the base station 300 (506).

As described above, the name tag type node 100 transmits the message to the server 200.

FIG. 13 is a sequential diagram of a message transmission/reception process to be performed between the name tag type nodes 100 according to the first embodiment of this invention.

This explanatory diagram shows a case where an inquiry is transmitted from a name tag type node A 100 to a name tag type node B 100.

The name tag type node A 100 starts the microcomputer 116 at a predetermined cycle (531). It should be noted that the name tag type node A 100 also starts the microcomputer 116 when information is input from the user.

Next, the name tag type node A 100 turns ON displaying on the LCD 107 (532). The name tag type node A 100 obtains (senses) various pieces of information by using the sensor 117 (533).

The user inputs an inquiry for a user of the name tag type node B 100 to the name tag type node A 100. The user may also select an inquiry message to be transmitted to the name tag type node B 100 from among the inquiry messages preregistered in the name tag type node A 100.

The name tag type node A 100 generates an inquiry message based on the information input from the user (534). Then, the name tag type node A 100 transmits the generated inquiry message to the base station 300 (535).

Next, the name tag type node 100 A turns OFF the displaying on the LCD 107 (536). The name tag type node A 100 sets the microcomputer 116 in a sleep state (537).

Meanwhile, the base station 300 receives the inquiry message from the name tag type node A 100, and transfers the received inquiry message to the server 200.

The server 200 receives the inquiry message from the base station 300, and determines a destination address of the received inquiry message. In this case, it is determined that the destination address of the inquiry message is the name tag type node B 100. A base station 300 that communicates with the judged name tag type node B 100 is retrieved (538).

Subsequently, the inquiry message is transferred to the retrieved base station 300 (539).

Then, the base station 300 receives the inquiry message from the server 200. The base station 300 holds the received inquiry message.

Meanwhile, the name tag type node B 100 starts the microcomputer 116 at a predetermined cycle (540). It should be noted that the name tag type node B 100 also starts the microcomputer 116 when information is input from the user.

Next, the name tag type node B 100 obtains (senses) various pieces of information by using the sensor 117 (541).

Next, the name tag type node B 100 makes an inquiry by radio to the base station 300 about whether the base station 300 holds a message addressed to the name tag type node B 100 (542).

Upon reception of the inquiry from the name tag type node B 100, the base station 300 judges whether it holds a message addressed to the name tag type node B 100 or not.

If it is judged that the message addressed to the name tag type node B 100 is not held, the base station 300 informs the name tag type node B 100 to that effect.

On the other hand, if it is judged that the message addressed to the name tag type node B 100 is held, the base station 300 transmits the message to the name tag type node B 100.

The name tag type node B 100 receives the inquiry message from the base station 300 (543).

Upon reception of the inquiry message, the name tag type node B 100 lights the LED 103 for a fixed time, and sounds the buzzer 111 for a fixed time simultaneously. Accordingly, the name tag type node B 100 notifies the reception of the message to the user.

Next, the name tag type node B 100 displays the received inquiry message on the LCD 107 (544).

The user inputs a reply for the displayed inquiry message to the name tag type node B 100. The user may also select a reply message to be returned to the name tag type node A 100 from among the reply messages preregistered in the name tag type node B 100.

The name tag type node B 100 generates a reply message based on the information input from the user. Then, the generated reply message is transmitted to the base station 300 (545).

Next, the name tag type node B 100 turns OFF the displaying on the LCD 107 (546). The name tag type node B 100 sets the microcomputer 116 in a sleep state (547).

Meanwhile, the base station 300 receives the reply message from the name tag type node B 100, and transfers the received reply message to the server 200.

The server 200 receives the reply message from the base station 300, and determines a destination address of the received reply message. In this case, it is determined that the destination address of the inquiry message is the name tag type node A 100. A base station 300 that communicates with the determined name tag type node A 100 is retrieved (548).

Subsequently, the reply message is transferred to the retrieved base station 300 (549).

Then, the base station 300 receives the reply message from the server 200. The base station 300 holds the received reply message.

Meanwhile, the name tag type node A 100 starts the microcomputer 116 at a predetermined cycle (550). It should be noted that the name tag type node A 100 also starts the microcomputer 116 when information is input from the user.

Next, the name tag type node A 100 obtains (senses) various pieces of information by using the sensor 117 (551).

Next, the name tag type node A 100 makes an inquiry by radio to the base station 300 about whether the base station 300 holds a message addressed to the name tag type node A 100 (552).

Upon reception of the inquiry from the name tag type node A 100, the base station 300 judges whether it holds a message addressed to the name tag type node A 100 or not.

If it is judged that the message addressed to the name tag type node A 100 is not held, the base station 300 informs the name tag type node A 100 to that effect.

On the other hand, if it is judged that the message addressed to the name tag type node A 100 is held, the base station 300 transmits the message to the name tag type node A 100.

The name tag type node A 100 receives the reply message from the base station 300 (553).

Upon reception of the reply message, the name tag type node A 100 lights the LED 103 for a fixed time, and sounds the buzzer 111 for a fixed time simultaneously (554). Accordingly, the name tag type node A 100 notifies the reception of the message to the user.

Next, the name tag type node A 100 displays the received inquiry message on the LCD 107 (555).

The name tag type node A 100 turns OFF the displaying on the LCD 107 after a passage of predetermined time (556). It should be noted that the name tag type node A 100 also turns OFF the displaying on the LCD 107 when the user executes a message checking operation.

The name tag type node A 100 sets the microcomputer 116 in a sleep state (547).

As described above, the message can be transmitted/received between the name tag type nodes 100.

### Second Embodiment

According to a second embodiment of this invention, entrance/exit control is carried out by using a name tag type node 100.

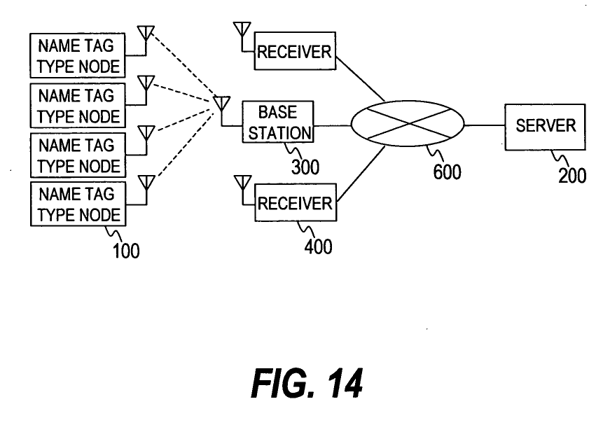

FIG. 14 is a block diagram of a sensor network system according to a second embodiment of this invention.

The sensor network system includes a name tag type node 100, a server 200, a base station 300, a receiver 400, and a network 600.

The receiver 400 is connected to the server 200 through the network 600. The receiver 400 monitors surrounding radio waves. Upon detection of an radio wave transmitted from the name tag type node 100, the receiver 400 notifies a node ID of the corresponding name tag type node 100 to the server 200. Accordingly, the server 200 can recognize that the name tag type node 100 exists near the receiver 400.

The receiver 400 has an radio wave detection sensitivity set lower than that of the base station 300. Thus, the receiver 400 detects an radio wave alone of a name tag type node 100 in its vicinity.

The name tag type node 100, the server 200, the base station 300, and the network 600 are similar to those of the sensor network system of the first embodiment shown in FIG. 1, and thus description thereof will be omitted.

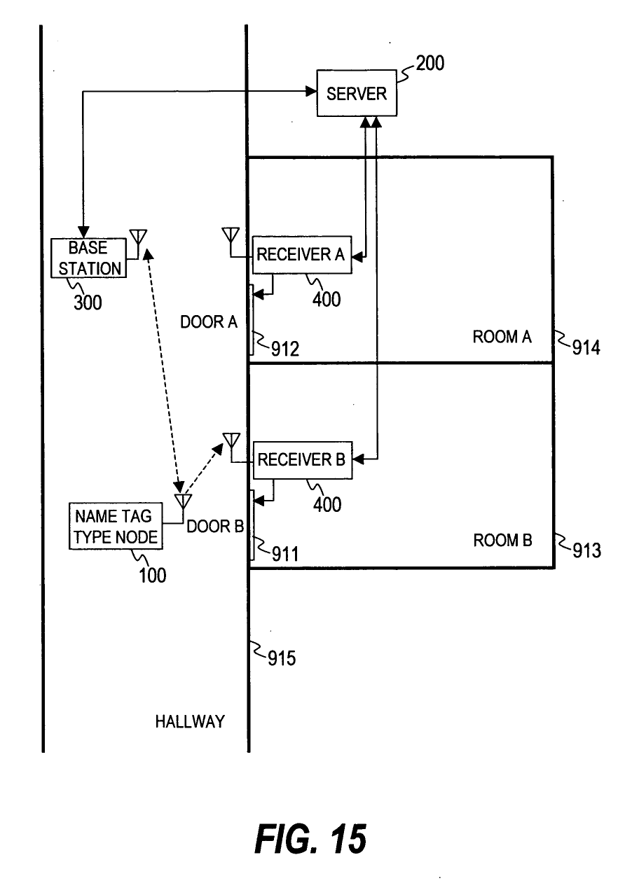

FIG. 15 is an explanatory diagram of how the sensor network system of the second embodiment of this invention is installed.

An area where the sensor network system is installed includes a hallway 915, a room A 914, and a room B 913. A door A 912 and a receiver A 400 are installed on the hallway 915 side of the room A 914. A door B 911 and a receiver B 400 are installed on the hallway 915 side of the room B 913. The base station 300 is installed in the hallway 915.

Description will be made of a case where a user having a name tag type node 100 moves around the area described above. The name tag type node 100 and the base station 300 carry out normal communication similar to that of the first embodiment.

In this case, the receiver B•400 near the name tag type node 100 detects an radio wave issued by the name tag type node 100. Next, the receiver B 400 determines the name tag type node 100 that has issued the radio wave based on the detected radio wave, and notifies a node ID of the determined name tag type node 100 to the server 200.

The receiver B 400 may also measure intensity of the detected radio wave to notify the measured intensity to the server 200. Hence, the server 200 can detect a position of the name tag type node 100 with high accuracy.

The server 200 judges whether to allow the user of the name tag type node 100 in the room based on entrance control information. When it is judged that entrance/exit permission is given to the user, the server 200 notifies the receiver B 400 to that effect.

Upon reception of the entrance/exit permission notification from the server 200, the receiver B 400 unlocks the door 911. Further, the receiver B 400 may also control the door 911 to automatically open.

As described above, the sensor network system of the embodiment according to this invention enables entrance/exit control of the user.

The name tag type node 100 of the embodiment according to this invention intermittently operates. Thus, when the name tag type node 100 is in a sleep state, the receiver 400 cannot detect the radio wave of the name tag type node 100.

Accordingly, when the name tag type node 100 starts communication with the base station 300, an operation interval thereof is made shorter. When an operation switch 108 is operated, the name tag type node 100 may transmit sensor data to the base station 300.

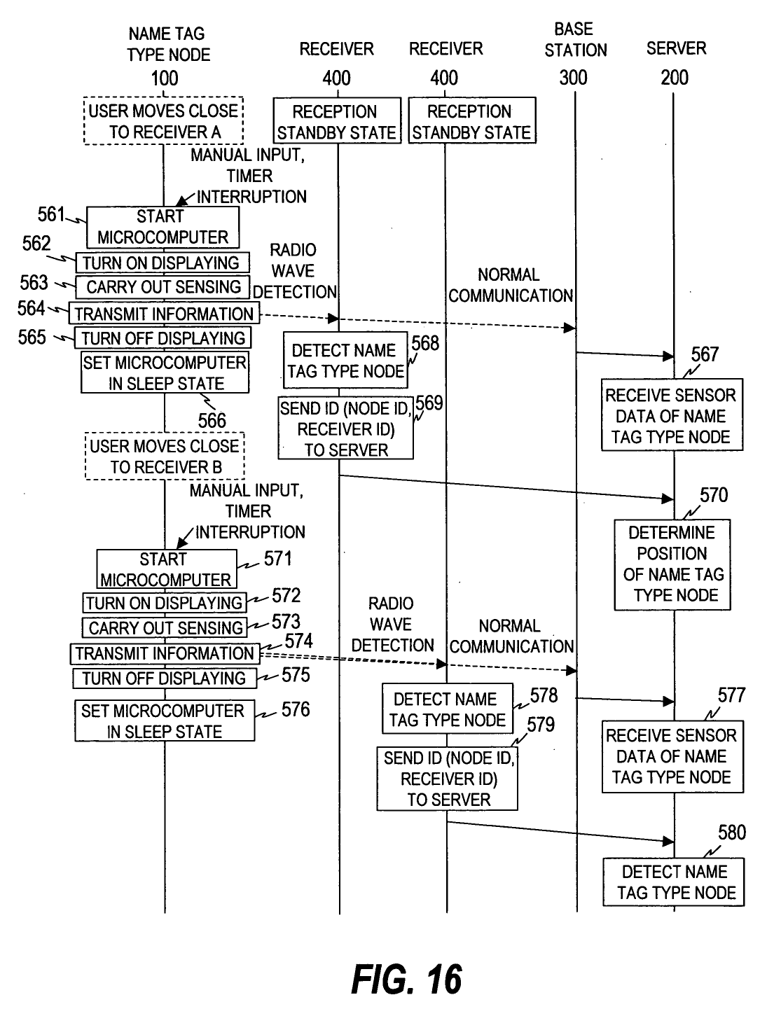

FIG. 16 is a sequential diagram of a position detection process of the sensor network system according to the second embodiment of this invention.

As shown in FIG. 16, the user of the name tag type node 100 moves from a position near the receiver A 400 to a position near the receiver B 400.

First, the user of the name tag type node 100 moves close to the receiver A 400.

At this time, the name tag type node 100 starts the microcomputer 116 at a predetermined cycle (561). It should be noted that the name tag type node 100 also starts the microcomputer 116 when information is input from the user.

Next, the name tag type node 100 turns ON the displaying on the LCD 107 (562). Next, the name tag type node 100 obtains (senses) various pieces of information by using the sensor 117 (563).

Next, the name tag type node 100 transmits the obtained information (sensor data) to the base station 300 (564).

Next, the name tag type node 100 turns OFF the displaying on the LCD 107 (565). The name tag type node 100 then sets the microcomputer 116 in a sleep state (566).

Meanwhile, the base station 300 receives the sensor data from the name tag type node 100, and transfers the received sensor data to the server 200.

The server 200 receives the sensor data from the base station 300 (567).

At this time, the receiver A 400 near the name tag type node 100 detects an radio wave of the sensor data transmitted from the name tag type node 100 (568).

The receiver A 400 determines the name tag type node 100 which has transmitted the radio wave based on the detected radio wave. Then, the receiver A 400 transmits a node ID of the determined name tag type node 100 and its own receiver ID to the server 200 (569).

The server 200 then receives the node ID and the receiver ID from the receiver A 400, and determines a position of the name tag type node 100 based on the received node ID and receiver ID (570). Specifically, the server 200 determines that the name tag type node 100 exists near the receiver A 400 corresponding to the received receiver ID.

Next, the user of the name tag type node 100 moves close to the receiver B 400.

At this time, the name tag type node 100 starts the microcomputer 116 at a predetermined cycle (571). It should be noted that the name tag type node 100 also starts the microcomputer 116 when information is input from the user.

Next, the name tag type node 100 turns ON the displaying on the LCD 107 (572). The name tag type node 100 obtains (senses) various pieces of information by using the sensor 117 (573).

Next, the name tag type node 100 transmits the obtained information (sensor data) to the base station 300 (574).

Next, the name tag type node 100 turns OFF the displaying on the LCD 107 (575). The name tag type node 100 then sets the microcomputer 116 in a sleep state (576).

Meanwhile, the base station 300 receives the sensor data from the name tag type node 100, and transfers the received sensor data to the server 200.

The server 200 receives the sensor data from the base station 300 (577).

At this time, the receiver B 400 near the name tag type node 100 detects an radio wave of the sensor data transmitted from the name tag type node 100 (578).

The receiver B 400 determines the name tag type node 100 which has transmitted the radio wave based on the detected radio wave. Then, the receiver B 400 transmits a node ID of the determined name tag type node 100 and its own receiver ID to the server 200 (579).

The server 200 receives the node ID and the receiver ID from the receiver B 400, and determines a position of the name tag type node 100 based on the received node ID and receiver ID (580). Specifically, the server 200 determines that the name tag type node 100 exists near the receiver B 400 corresponding to the received receiver ID.

As apparent from the foregoing, by including the receiver, the sensor network system of the embodiment enables determination of the position of the name tag type node. Hence, the sensor network system of the embodiment can be applied not only to entrance/exit control but also to moving object monitoring.

This invention can be applied to a name tag carried to be used in an exhibition hall, a lecture hall, a company, a hospital, public facilities, or the like.

While the present invention has been described in detail and pictorially in the accompanying drawings, the present invention is not limited to such detail but covers various obvious modifications and equivalent arrangements, which fall within the purview of the appended claims.

What is claimed is:

1. An electronic apparatus, which functions as a name card having a name written on a front side thereof, comprising:
a radio communication apparatus;
a secondary battery;
a solar battery on the front side; and
a display unit on a backside thereof,
wherein the solar battery is installed to be tilted to make a distance between an upper side thereof and the display unit smaller than a distance between a lower side thereof and the display unit.

2. The electronic apparatus according to claim 1, wherein the secondary battery is installed lower than a center of the electronic apparatus.

3. The electronic apparatus according to claim 1, wherein the electronic apparatus is made thinner at an upper portion thereof than at a bottom portion thereof.

4. The electronic apparatus according to claim 1, wherein the secondary battery is a lithium-ion secondary battery.

5. The electronic apparatus according to claim 1, further comprising an operation switch on the backside,
wherein the display unit stops displaying when the operation switch is operated.

6. The electronic apparatus according to claim 1, further comprising an antenna that is disposed not to overlap the solar battery or the display unit when viewed from the front side.

7. The electronic apparatus according to claim 1, wherein:
the electronic apparatus measures a voltage generated by the solar battery and calculates an ambient illuminance based on the measured voltage.

8. A sensor network system, comprising:
an electronic apparatus including a radio communication apparatus and a secondary battery and having a name written on a front side thereof;
a server for communicating with the electronic apparatus; and
a base station for relaying communication between the electronic apparatus and the server, wherein:
the electronic apparatus includes: a solar battery on the front side; and a display unit on a backside thereof; and
the solar battery is installed to be tilted to make a distance between an upper side thereof and the display unit smaller than a distance between a lower side thereof and the display unit.

9. The sensor network system according to claim 8, wherein the electronic apparatus transmits information input from a user to the server.

10. The sensor network system according to claim 8, wherein:
the electronic apparatus further includes a sensor for measuring a surrounding situation and transmits the surrounding situation measured by the sensor to the server.

11. The sensor network system according to claim 8, wherein the server transfers the information received from the electronic apparatus to another electronic apparatus.

12. The sensor network system according to claim 8, wherein the server stores event action information indicating a process corresponding to the information received from the electronic apparatus, determines the process corresponding to the received information based on the event action information upon reception of the information from the electronic apparatus, and executes the determined process.

13. A sensor network system, comprising:
an electronic apparatus including a radio communication apparatus and a secondary battery and having a name written on a front side thereof;
a server for communicating with the electronic apparatus;
a base station for relaying communication between the electronic apparatus and the server; and
a receiver for detecting radio waves of radio communication between the electronic apparatus and the base station, wherein:
the electronic apparatus further includes:
a solar battery on the front side; and
a display unit on a backside thereof; and
the solar battery is installed to be tilted to make a distance between an upper side thereof and the display unit smaller than a distance between a lower side thereof and the display unit.

14. The sensor network system according to claim 13, wherein:
the receiver transmits a detection notification to the server upon detection of the radio waves of the radio communication between the electronic apparatus and the base station; and
the server determines a position of the electronic apparatus based on the received detection notification.
